(19) United States
(12) Patent Application Publication
(10) Pub. No.: US 2024/0326734 A1
(43) Pub. Date: Oct. 3, 2024

(54) VARIABLE VENT MECHANISM, AIRBAG DEVICE, AND FLAP MECHANISM

(71) Applicant: TOYODA GOSEI CO., LTD., Kiyosu-shi (JP)

(72) Inventors: Yusuke KAWAMURA, Aichi (JP); Yuji SATO, Aichi (JP); Koji KAWAMURA, Aichi (JP); Motoyuki TANAKA, Aichi (JP); Atsushi NAKAMURA, Aichi (JP); Yuya SUZUKI, Aichi (JP)

(21) Appl. No.: 18/621,457

(22) Filed: Mar. 29, 2024

(30) Foreign Application Priority Data
Apr. 3, 2023 (JP) 2023-060487

(51) Int. Cl. B60R 21/239; B60R 21/203

(52) U.S. Cl. CPC B60R 21/239; B60R 21/203

(57) ABSTRACT

A variable vent mechanism has an air bag having a vent hole, a flap attached to the air bag at a first fix portion and covering the vent hole, a strap extending from a connection end of the flap, fixed to an attachment portion at a second fix portion, and fixing the flap in a closed position where the vent hole is closed, and a device which brings the strap into a free state. A relationship L3/L4 between a maximum length L3 between the first fix portion and the connection end in a first direction connecting the first and second fix portions, and a maximum length L4 of the first fix portion in a second direction orthogonal to the first direction satisfies 0.5≤L3/L4≤3.0. A length of the flap in the second direction is shorter on the connection end side than on the first fix portion side.

### CROSS-REFERENCE TO RELATED APPLICATIONS

This application is based on and claims priority under 35 USC 119 from Japanese Patent Application No. 2023-060487 filed on Apr. 3, 2023, the entire content of which is incorporated herein by reference.

### TECHNICAL FIELD

The present disclosure relates to a variable vent mechanism, an airbag device including the variable vent mechanism, and a flap mechanism included in the variable vent mechanism.

### BACKGROUND ART

Various types of airbag devices are known in which, during a collision of a vehicle, an inflation fluid such as gas generated by an inflation fluid generation source such as an inflator is supplied to an air bag connected to the inflation fluid generation source, and the air bag is deployed and inflated between a vehicle body and an occupant to protect the occupant.

In the airbag device, in order to protect the occupant from an impact caused by the collision, it is necessary to supply the inflation fluid rapidly and sufficiently to the air bag during the deployment and inflation. However, on the other hand, since a larger reaction force is applied to the occupant by the air bag, the occupant feels a significant discomfort. If the reaction force is excessive, a large impact is applied to the occupant, and as a result, a burden may be applied to a body of the occupant.

In order to avoid the above problem caused when the air bag is deployed and inflated, a technique of providing a variable vent mechanism in the airbag device has been proposed. In the airbag device including the variable vent mechanism, a vent hole formed to be opened is provided with the air bag.

In the airbag device including the variable vent mechanism, in an initial stage during deployment and inflation of the air bag, the vent hole is closed to rapidly supply a sufficient amount of inflation fluid to the air bag, and an internal pressure of the air bag is increased to an extent sufficient to protect the occupant. Then, the vent hole is opened to cause the inflation fluid in the air bag to flow to an outside, thereby reducing the internal pressure of the air bag. Accordingly, the reaction force applied to the occupant can be reduced.

Various methods have been proposed as a method for opening and closing the vent hole of the air bag (for example, see US2017-0158161A).

US2017-0158161A discloses an airbag device (air bag cushion assembly 100) including a vent opening 112 provided in an air bag (air bag cushion 110) and a strap (tether 130) attached to the vent opening 112.

According to the technique disclosed in US2017-0158161A, the air bag is deployed and inflated in a state where the vent hole provided in the vent opening of the air bag is closed by the strap. Thereafter, the strap is broken to open the vent hole, and the inflation fluid in the air bag flows to the outside. Accordingly, the internal pressure of the air bag can be reduced.

However, in the airbag device disclosed in US2017-0158161A, a part of the bag-shaped air bag is narrowed into a thin tubular shape, and a tip of the tubular portion is opened to form a vent hole.

In a closed state in which the vent hole is closed, the tubular portion is folded back to the inside of the air bag and is fastened with the strap.

In the air bag in the variable vent mechanism disclosed in US2017-0158161A, as described above, the vent hole is formed at the tip of the portion narrowed into a thin tubular shape of the air bag. By providing such a tubular portion, a large amount of base cloth is required for the air bag, and a mass of the air bag is increased by the tubular portion.

Further, in order to change the vent hole from the closed state to the open state, it is necessary not only to break the strap, but also to deploy the tubular portion folded back to the inside of the air bag to the outside of the air bag. According to the variable vent mechanism of this type, the above-described complicated steps are required to open the vent hole. Therefore, according to the variable vent mechanism, it is necessary to improve the responsivity of an opening operation for opening the vent hole.

Thus, the variable vent mechanism in the related art is insufficient in respect of opening and closing operation characteristics.

### SUMMARY OF INVENTION

An object of the present disclosure is to provide a technique capable of improving the opening and closing operation characteristics of the variable vent mechanism.

The first aspect of the present disclosure provides a variable vent mechanism including:
an air bag being in a bag-shape, and having a vent hole formed to be opened and provided on a bag wall surface of the air bag;
a flap attached to the air bag at a first fix portion, and configured to cover the vent hole;
a strap extending from a connection end of the flap, fixed to a strap attachment portion at a second fix portion, and configured to fix the flap in a closed position where the vent hole is closed; and
a closed state release device bringing the strap into a free state to change a position of the flap from the closed position,
in which in the flap, a relationship L3/L4 between a maximum length L3 between the first fix portion and the connection end in a first direction connecting the first fix portion and the second fix portion, and a maximum length L4 of the first fix portion in a second direction orthogonal to the first direction satisfies 0.5≤L3/L4≤3.0, and
a length of the flap in the second direction is shorter on a side of the connection end than that on a side of the first fix portion.

The second aspect of the present disclosure provides an airbag device including the above-described variable vent mechanism of the first aspect of the present disclosure.

The third aspect of the present disclosure provides a flap mechanism including:
a flap attached, at a first fix portion, to an air bag being in a bag-shape and having a vent hole formed to be opened and provided on a bag wall surface of the air bag, and configured to cover the vent hole; and
a strap extending from a connection end of the flap, fixed to a strap attachment portion at a second fix portion, and configured to fix the flap in a closed position where the vent hole is closed,
in which in the flap, a relationship L3/L4 between a maximum length L3 between the first fix portion and the connection end in a first direction connecting the first fix portion and the second fix portion, and a maximum length L4 of the first fix portion in a second direction orthogonal to the first direction satisfies 0.5≤L3/L4≤3.0, and
a length of the flap in the second direction is shorter on a side of the connection end than that on a side of the first fix portion.

According to the variable vent mechanism, the airbag device, and the flap mechanism of the present disclosure, it is possible to improve the opening and closing operation characteristics of the variable vent mechanism.

### BRIEF DESCRIPTION OF DRAWINGS

Exemplary embodiment(s) of the present invention will be described in detail based on the following figures, wherein:

FIG. 1 is an explanatory diagram schematically illustrating an airbag device of Example 1 in a state where an air bag is deployed and inflated;

FIG. 2 is an explanatory diagram schematically illustrating the airbag device of Example 1 in a state where the air bag is deployed and inflated;

FIG. 3 is an explanatory diagram schematically illustrating a flap mechanism and a vent hole provided in the airbag device of Example 1;

FIG. 4 is an explanatory diagram schematically illustrating a state in which a flap closes the vent hole of the air bag in the airbag device of Example 1;

FIG. 5 is an explanatory diagram schematically illustrating a state in which the flap closes the vent hole of the air bag in the airbag device of Example 1;

FIG. 6 is an explanatory diagram schematically illustrating a state in which the flap opens the vent hole of the air bag in the airbag device of Example 1;

FIG. 7 is an explanatory diagram schematically illustrating a state in which the flap opens the vent hole of the air bag in the airbag device of Example 1;

FIG. 8 is an explanatory diagram schematically illustrating an airbag device of Example 2 in a state where an air bag is deployed and inflated;

FIG. 9 is an explanatory diagram schematically illustrating a flap mechanism and a vent hole provided in an airbag device of a comparative example;

FIG. 10 is an explanatory diagram schematically illustrating a flap mechanism and a vent hole provided in an airbag device of Example 3;

FIG. 11 is an explanatory diagram schematically illustrating a flap mechanism and a vent hole provided in an airbag device of Example 4;

FIG. 12 is an explanatory diagram schematically illustrating a flap mechanism and a vent hole in an airbag device of Example 5;

FIG. 13 is an explanatory diagram schematically illustrating a flap mechanism and a vent hole provided in an airbag device of Example 6;

FIG. 14 is an explanatory diagram schematically illustrating a flap mechanism and a vent hole provided in an airbag device of Example 7;

FIG. 15 is an explanatory diagram schematically illustrating a flap mechanism and a vent hole in an airbag device of Example 8; and

FIG. 16 is an explanatory diagram schematically illustrating a flap mechanism and a vent hole provided in an airbag device of Example 9.

### DESCRIPTION OF EMBODIMENTS

A variable vent mechanism of the present disclosure includes an air bag, a flap, a strap, and a closed state release device.

The air bag is in a bag-shape, and has a vent hole formed to be opened and provided on a bag wall surface of the air bag. The vent hole is covered by the flap, and the flap is fixed in a closed position where the vent hole is closed by a strap extending from the flap.

The closed state release device brings the strap into a free state. Accordingly, the position of the flap fixed in the closed position changes. That is, the vent hole is opened in this case.

As described above, in the variable vent mechanism of the present disclosure, since the vent hole is closed by the flap, it is not necessary to provide a tubular portion as introduced in US2017-0158161A described above in the air bag.

In the variable vent mechanism of the present disclosure, the flap is fixed in the closed position by the strap extending from the flap itself. Therefore, when the strap is brought to be in the free state, the flap opens the vent hole.

Therefore, according to the variable vent mechanism of the present disclosure, the vent hole can be opened with a relatively simple action mechanism, and responsiveness of an opening operation of opening the vent hole is excellent. That is, the variable vent mechanism of the present disclosure can be said to improve opening and closing operation characteristics.

Further, in the variable vent mechanism of the present disclosure, the flap is attached to the air bag at a first fix portion. The strap extending from a connection end of the flap is fixed to a strap attachment portion at a second fix portion. Accordingly, a tension in a first direction, that is, in a direction in which the first fix portion and the second fix portion are connected to each other acts on an integrated product of the flap and the strap.

In such a flap, a relationship L3/L4 between a maximum length L3 between the first fix portion and the connection end in the first direction, and a maximum length L4 of the first fix portion in a second direction orthogonal to the first direction satisfies 0.5≤L3/L4≤3.0. A length of the flap in the second direction is shorter on a side of the connection end than that on a side of the first fix portion.

By forming the flap in the above-described shape, it is possible to increase the tension acting on the flap and the strap in the closed position where the vent hole is closed. By increasing the tension, the vent hole can be effectively closed by the flap and the strap. Further, if the tension is high, a reaction force when the strap is brought into the free state is also increased, and thus the vent hole can be rapidly opened.

With this cooperation, the opening and closing operation characteristics of the variable vent mechanism of the present disclosure are further improved.

According to the variable vent mechanism of the present disclosure, since the vent hole is effectively closed by increasing the tension acting on the flap and the strap in the closed position as described above, a function of sufficiently restraining an occupant in an initial stage of deployment and inflation of the air bag can be imparted to the airbag device. In addition, by rapidly opening the vent hole thereafter, it is also possible to provide the airbag device with a function of rapidly and sufficiently reducing a reaction force applied to the occupant and effectively reducing a burden applied to a body of the occupant.

The flap mechanism of the present disclosure is a flap mechanism included in the variable vent mechanism of the present disclosure.

According to the flap mechanism of the present disclosure, similarly to the variable vent mechanism of the present disclosure, the opening and closing operation characteristics of the variable vent mechanism can be improved. Further, according to the flap mechanism of the present disclosure, similarly to the variable vent mechanism of the present disclosure described above, there is an advantage that the function of sufficiently restraining the occupant at the initial stage of deployment and inflation of the air bag and the function of effectively reducing the burden on the body of the occupant can be imparted to the airbag device.

An airbag device of the present disclosure is an airbag device including the above- described variable vent mechanism of the present disclosure.

According to the air bag mechanism of the present disclosure, similarly to the variable vent mechanism of the present disclosure, the opening and closing operation characteristics of the variable vent mechanism are improved. Further, similarly to the variable vent mechanism of the present disclosure described above, there is also an advantage that the occupant can be sufficiently restrained at the initial stage of deployment and inflation of the air bag and the burden on the body of the occupant can be effectively reduced.

Hereinafter, each component of the variable vent mechanism, the flap for the variable vent mechanism, and the airbag device of the present disclosure will be described.

Unless otherwise specified, the components are common among the variable vent mechanism, the flap for the variable vent mechanism, and the airbag device of the present disclosure.

Unless otherwise specified, a numerical value range “x to y” described in the present specification includes a lower limit value x and an upper limit value y. The upper limit value, the lower limit value, and numerical values listed in the embodiments may be freely combined to form a new numerical value range. Further, a numerical value freely selected from the above-described numerical value range can be set as an upper limit numerical value or a lower limit numerical value of a new numerical value range.

As described above, the airbag device of the present disclosure is an airbag device including the variable vent mechanism of the present disclosure, and the flap mechanism of the present disclosure is a flap mechanism included in the variable vent mechanism of the present disclosure. Therefore, first, the variable vent mechanism will be described below.

### Variable Vent Mechanism

The variable vent mechanism is a part of the airbag device, and adjusts an internal pressure of the air bag by opening and closing the vent hole formed to be opened and provided with the air bag as described above.

Specifically, the variable vent mechanism of the present disclosure includes the air bag, the flap, the strap, and the closed state release device.

The air bag is in a bag-shape, and has the vent hole formed to be opened and provided on a bag wall surface of the air bag. That is, the vent hole in the variable vent mechanism of the present disclosure is not provided at a tip of a portion which is a part of an air bag being in a bag-shape and is narrowed in a thin tubular shape as introduced in US2017-0158161A, but is directly provided on a wall surface itself constituting a bag-shaped portion which is a main body of the air bag.

Accordingly, unlike the air bag introduced in US2017-0158161A, the air bag in the variable vent mechanism of the present disclosure does not require a thin tubular portion. In the variable vent mechanism of the present disclosure, instead of folding the thin tubular portion to close the vent hole, the vent hole opened on the bag wall surface is closed using the flap and the strap.

The air bag is in a bag-shape, and as described above, is connected to an inflation fluid generation source, and protects the occupant by deploying and inflating by receiving supply of an inflation fluid during an impact. The air bag may be disposed in any portion of the vehicle, and for example, it is particularly preferable that the air bag is mounted on a steering wheel or mounted on a portion of a back surface side of an instrument panel positioned in front of a front passenger seat, and is interposed between the occupant and a windshield.

Such an air bag is normally folded and stored. Therefore, as a material of the air bag, it is preferable to select a material that can be folded and deployed.

As a specific material of the air bag, a flexible and high-strength material is preferably selected, and for example, a woven fabric using a high-strength resin fiber such as polyester and polyamide can be particularly preferably used.

The vent hole formed to be opened is provided on the bag wall surface of the air bag. The number of vent holes provided on the same air bag may be one or more. The vent hole needs to communicate an inside and an outside of the air bag so as to discharge the inflation fluid inside the air bag to the outside. When the air bag has a plurality of vent holes, the vent holes may have the same shape or different shapes.

In the variable vent mechanism of the present disclosure, the shape of the vent hole is not particularly limited, and may be, for example, a perfect-circle shape, and is preferably a long-hole shape. A longitudinal direction of the vent hole having a long-hole shape may be oriented in any direction, but the longitudinal direction is preferably oriented in the first direction. In the present specification, the longitudinal direction of the vent hole means a direction in which an opening diameter of the vent hole is largest. A short direction of the vent hole means a direction orthogonal to the longitudinal direction.

It is preferable that the vent hole having a long-hole shape has a shape in which both ends of two straight lines extending in the longitudinal direction are connected by curved lines as a track of athletic competition, for example. Specific examples of the shape may include a shape in which two perfect circles having the same radius are connected by common external lines (so-called oval, single focal point circle), a shape in which two ellipses having the same radius are connected by common external lines, and a shape in which corners of a rectangle are curved. The vent hole having a long-hole shape may be elliptical.

In order to ensure a larger opening area of the vent hole provided in a limited space, it is particularly preferable that the vent hole has a shape in which both ends of two straight lines extending in the longitudinal direction are connected by curved lines.

When the air bag in the variable vent mechanism of the present disclosure has a plurality of vent holes, one vent hole may have a long-hole shape, and the other vent holes may not have a long-hole shape.

When the vent hole has a long-hole shape, a maximum length L1 in the first direction of the vent hole and a maximum length L2 in the second direction orthogonal to the first direction satisfy L1>L2, but there is a preferable relationship between L1 and L2.

Specifically, in the variable vent mechanism of the present disclosure, it is particularly preferable that the relationship L1/L2 between L1 and L2 satisfies 1.0<L1/L2≤3.0, 1.05≤L1/L2≤3.0, 1.1≤L1/L2≤3.0, or 1.2≤L1/L2≤3.0.

The reason for this will be described in detail, and when the relationship L1/L2 between L1 and L2 is within the above ranges, there is an advantage that a shape of the flap can be a shape capable of obtaining a stronger tension.

Since the vent hole in the variable vent mechanism of the present disclosure is provided on the bag wall surface of the air bag as described above, the air bag in the variable vent mechanism of the present disclosure does not require a thin tubular portion for providing the vent hole. However, the air bag in the variable vent mechanism of the present disclosure may have a thin tubular portion as long as it is not related to the vent hole.

The flap is attached to the air bag and covers the vent hole. The strap extends from the flap, is fixed to the strap attachment portion, which is a mating member, and fixes the flap in a position (closed position) where the vent hole is closed. The strap may be fixed to the strap attachment portion via a fixing material, or may be directly fixed to the strap attachment portion by being tied to the strap attachment portion or the like.

When the air bag has the plurality of vent holes as described above, the flap may cover all the vent holes. In other words, the variable vent mechanism of the present disclosure may have a number of flaps corresponding to the vent holes.

Alternatively, if the air bag has a plurality of vent holes, the flap may cover only some of the vent holes, and the remaining vent holes may not be covered by the flap. When some of the vent holes have a long-hole shape and the remaining vent holes do not have a long-hole shape, it is preferable to cover the vent holes having a long-hole shape with the flap.

The flap needs to be capable of covering the vent hole in the closed position and capable of opening the vent hole away from the vent hole in an open position. Such a flap has a first fix portion attached to the air bag. The strap extends from the connection end of the flap.

The first fix portion may also be referred to as an end of the flap in the first direction. The connection end is preferably positioned at the other end of the flap in the first direction.

In the flap in the variable vent mechanism of the present disclosure, a relationship L3/L4 between a maximum length L3 between the first fix portion and the connection end in the first direction and a maximum length L4 of the first fix portion in the second direction satisfies 0.5≤L3/L4≤3.0. A length of the flap in the second direction is shorter on a side of the connection end than that on a side of the first fix portion.

The reason for this will be described in detail, and by forming the flap into such a shape, it is possible to further increase the tension acting on the flap in the closed position and to open the vent hole more rapidly in the open position.

There are various shapes of the flap that satisfy this condition, and in any case, it is possible to obtain sufficient tension in the closed position to close the vent hole, but there is also a particularly preferable shape of the flap.

It is more preferable that L3/L4 satisfies 0.7≤L3/L4≤2.0, 0.75≤L3/L4≤1.5, or 0.8≤L3/L4≤1.5.

Further, in the variable vent mechanism of the present disclosure, it is sufficient that the length of the flap in the second direction is shorter on the side of the connection end than that of the side of the first fix portion. For example, there may be a portion of the flap that is shorter in length in the second direction on the side of the connection end than that on the side of the first fix portion.

Alternatively, the length of the flap in the second direction may be reduced stepwise from the side of the first fix portion toward the side of the connection end.

In the variable vent mechanism of the present disclosure, it is particularly preferable that a region of the flap on the side of the connection end is sandwiched between a first side and a second side, and the region has a tapered shape in which a distance between the first side and the second side decreases from the side of the first fix portion toward the side of the connection end.

By forming the flap into the various shapes described above, the tension acting on the flaps in the closed position can be further increased.

When the region of the flap on the side of the connection end has the tapered shape described above, it is preferable that an angle θ between the first side and the second side is not excessively large in order to avoid dispersion of the tension. Specifically, the angle θ is preferably 150° or less, particularly preferably in a range of 30°≤θ≤120°, 60°≤θ≤110°, or 80°≤θ≤100°.

A material of the flap is not particularly limited, and it is preferable that the flap is folded together with the air bag and does not easily interfere with the deployment and inflation of the air bag. As a material of such a flap, a material having flexibility and high strength is preferably selected, and a woven fabric using a high-strength resin fiber such as polyester and polyamide as in the case of the air bag is particularly preferably selected.

The first fix portion in the flap is attached to the air bag.

As a method for attaching the flap to the air bag, any method may be selected as long as the method does not hinder the deployment, inflation, and the like of the air bag. For example, the air bag and the flap may be integrally formed, or a flap formed separately from the air bag may be sewn, bonded, or welded to the air bag.

The flap may cover the vent hole inside the air bag or may cover the vent hole outside the air bag.

The strap may have any shape as long as it can extend from the connection end of the flap and be fixed to the strap attachment portion at a second fix portion, such as a string shape or a band shape, but is not limited thereto.

The strap and the flap may be integrally formed, or a strap formed separately from the flap may be sewn, bonded, or welded to the flap. As a material of the strap, a material having flexibility and high strength is preferably selected, and a woven fabric using a high-strength resin fiber such as polyester and polyamide is particularly preferably selected as in the case of the flap.

When the strap is fixed to a strap fix portion by a fixing material, it is preferable to select a flexible and high-strength material as a material of the fixing material. In a case where the fixing material is broken by heat as in an embodiment described later, one that can be broken by heat may be selected as the fixing material. As the material of the fixing material in this case, a high-strength resin fiber having thermoplasticity such as polyester, polyamide, and polyethylene terephthalate is particularly preferably selected.

The strap attachment portion to which the strap is fixed may be a part of the airbag device, or may be a vehicle component or a vehicle interior component disposed in the vicinity of the airbag device. For example, if the airbag device is mounted on a steering wheel, the strap may be fixed to the steering wheel or may be fixed to a base (so-called bag plate) for attaching the air bag to the steering wheel. Alternatively, the strap may be fixed to the air bag itself. In each case, the steering wheel, the base, or the air bag serves as the strap attachment portion.

When the strap is fixed to the strap attachment portion by a fixing material, the material and shape of the fixing material may be appropriately selected depending on a positional relationship between the strap and the strap attachment portion, materials and shapes of the strap and the strap attachment portion, and the like. For example, in a case where the strap attachment portion is the air bag, the fixing material preferably has a sewing thread-like shape that sews the strap to the air bag. In this case, further, when the fixing material having the sewing thread-like shape is broken by heat of a heating portion, the fixing material is particularly preferably formed of a material that is more easily broken by heat, for example, a sewing thread made of a thermoplastic resin. Note that the sewing thread in the present specification refers to a thread that can be used for sewing, and a material, a spinning method, a fiber length, and the like thereof are not limited.

The strap may be fixed to the outside of the air bag or may be fixed to the inside of the air bag.

### Airbag Device

The airbag device of the present disclosure includes the above-described variable vent mechanism of the present disclosure. The components of the variable vent mechanism of the present disclosure have already been described.

The airbag device of the present disclosure may include an inflation fluid generation source for supplying an inflation fluid to the air bag.

The inflation fluid generation source preferably uses a so-called inflator that generates gas as the inflation fluid, and in some cases, the inflation fluid generation source may generate an inflation fluid other than gas, for example, liquid or gel.

The inflation fluid generation source may be a device for supplying the inflation fluid to the air bag, and may be, for example, a so-called pyrotechnic type device including a gas generating agent that generates gas as the inflation fluid or a so-called hybrid type device in which a partition wall of a high-pressure container is broken and gas contained in the high-pressure container is supplied. The inflation fluid generation source may be entirely disposed outside the air bag, or may be partially or entirely disposed inside the air bag.

The airbag device may include other components. Examples of the other components include a retainer that houses at least a part of the inflation fluid generation source, a cover that surrounds at least a part of the air bag, and a wire harness for electrically connecting the inflation fluid generation source and an air bag control device, but the airbag device is not limited thereto, and may include other components.

Hereinafter, the variable vent mechanism, the airbag device, and the flap mechanism of the present disclosure will be described with reference to specific embodiments.

### Example 1

An airbag device of Example 1 is a driver seat airbag device mounted on a steering wheel of a vehicle. The airbag device of Example 1 includes a variable vent mechanism of Example 1 and a flap mechanism of Example 1, and the variable vent mechanism of Example 1 includes the flap mechanism of Example 1. Hereinafter, the description “in the airbag device of Example 1” and the like can be appropriately read as “in the variable vent mechanism of Example 1” and “in the flap mechanism of Example 1”.

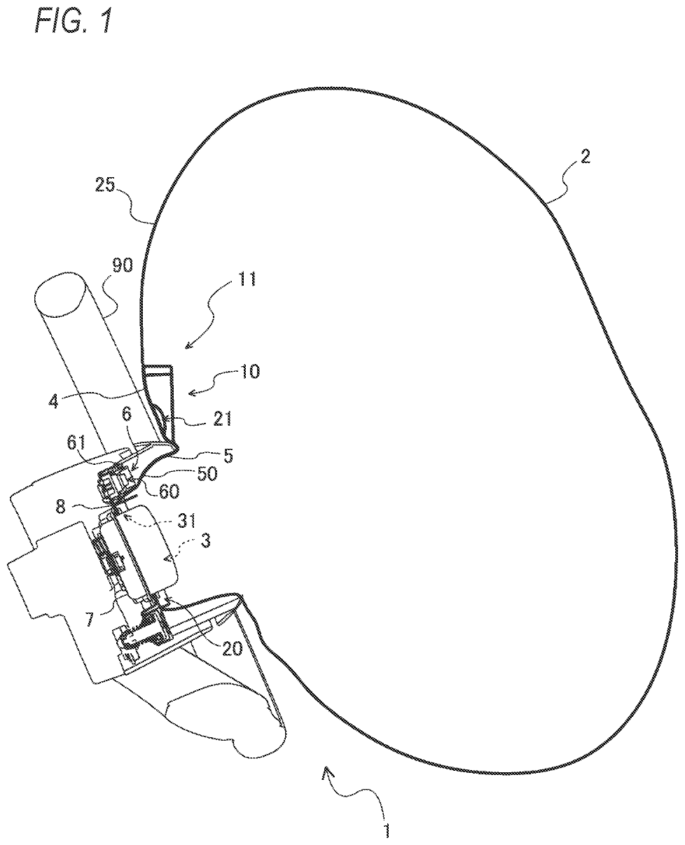

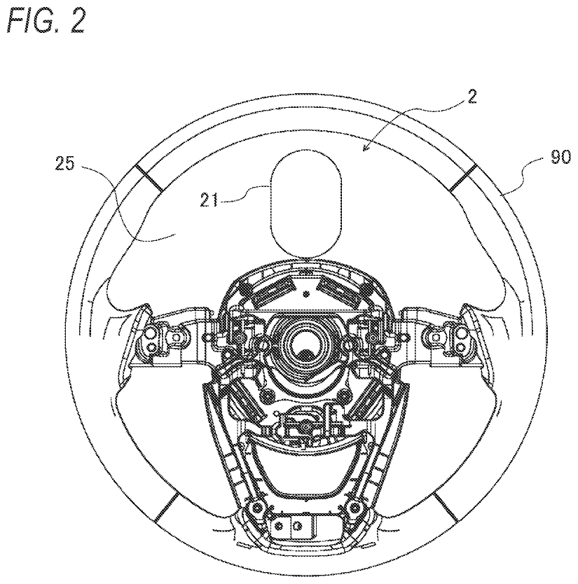

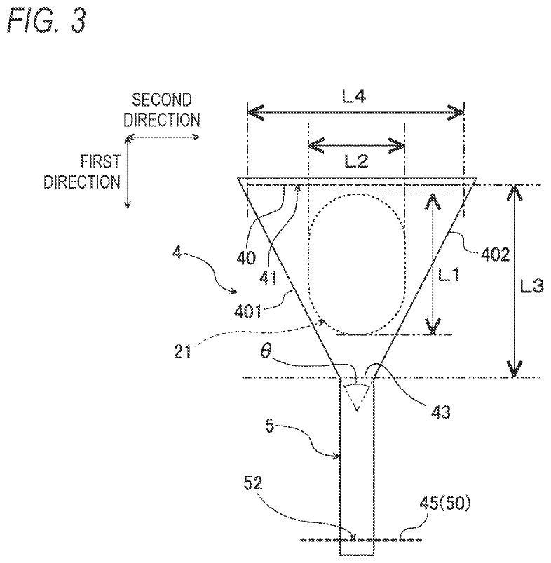

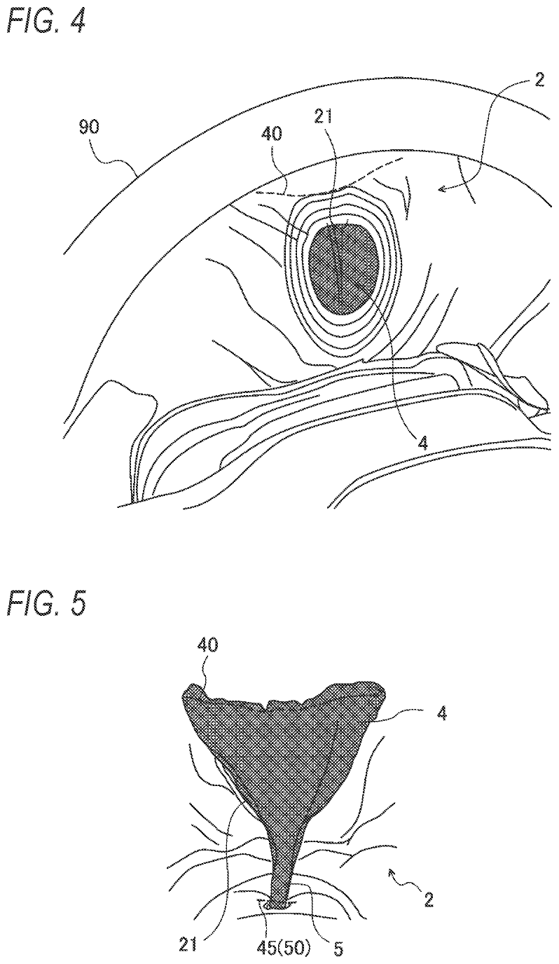

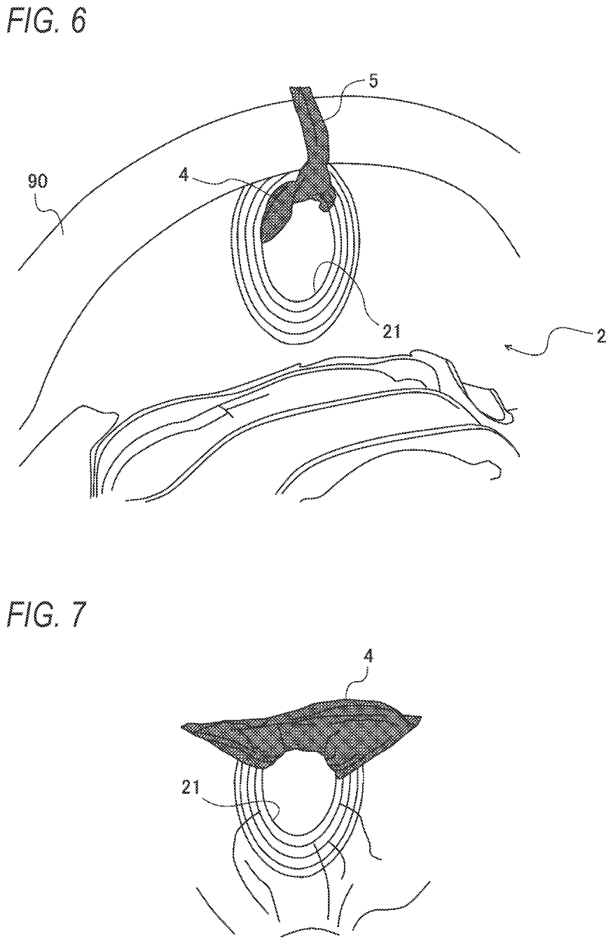

FIGS. 1 and 2 are explanatory diagrams schematically illustrating the airbag device of Example 1 in a state where an air bag is deployed and inflated. Note that FIG. 1 schematically shows a state in which the airbag device of Example 1 is cut, and FIG. 2 schematically shows a state in which the air bag of Example 1 is viewed from the steering wheel side. FIG. 3 is an explanatory diagram schematically illustrating the flap mechanism and a vent hole in the airbag device of Example 1. FIGS. 4 and 5 are explanatory diagrams schematically illustrating a state in which a flap closes the vent hole of the air bag in the airbag device of Example 1. FIGS. 6 and 7 are explanatory diagrams schematically illustrating a state in which the flap opens the vent hole of the air bag in the airbag device of Example 1. Note that FIG. 5 illustrates the vent hole and the flap illustrated in FIG. 4 as viewed from a back side. FIG. 7 illustrates the vent hole and the flap illustrated in FIG. 6 as viewed from the back side.

As shown in FIG. 1, an airbag device 1 of Example 1 includes an air bag 2, an inflation fluid generation source 3, a flap 4, a strap 5, a closed state release device 6, a case 7, and a base 8. Note that the base 8 is a member for attaching the airbag device 1 of Example 1 to a steering wheel 90 of the vehicle.

The flap 4 and the strap 5 constitute a flap mechanism 10 of Example 1. An air bag 21, the flap 4, the strap 5, and the closed state release device 6 constitute a variable vent mechanism 11 of Example 1.

The inflation fluid generation source 3 in the airbag device 1 of Example 1 is an inflator 3 that generates gas as an inflation fluid, and includes an inflation fluid generation squib (not shown) for starting the generation of gas in the inflator 3. The inflator 3 includes a gas outlet 31 for blowing out gas, and the inflation fluid generation squib is connected to a control device (not shown) for deploying and inflating the air bag 2 and is operated by being supplied with electric power.

The air bag 2 is in a hollowed bag-shape, and the gas outlet 31 of the inflator 3 is connected to an opening 20 of the air bag 2 and can supply gas, that is, the inflation fluid, into the air bag 2.

As shown in FIGS. 2, 4 and 5, a vent hole 21 opening in a long-hole shape is provided on a bag wall surface 25 of the air bag 2. The vent hole 21 establishes communication between an inside and an outside of the air bag 2.

As shown in FIGS. 3 to 5, the flap 4 is sewn around the vent hole 21 of the air bag 2 by a first sewing thread 40. A portion of the flap 4 sewn to the air bag 2 is referred to as a first fix portion 41.

As shown in FIG. 3, the strap 5 is integrated with a connection end 43 of the flap 4.

Further, an end of the strap 5 on an opposite side from the flap 4 is sewn to the air bag 2 with a second sewing thread 45.

The airbag device 1 and the air bag 2 provided in the variable vent mechanism 11 of Example 1 correspond to the airbag device 1 and the strap attachment portion provided in the variable vent mechanism of the present disclosure. A portion of the strap 5 sewn to the air bag 2 is referred to as a second fix portion 52.

The strap 5 is sewn and fixed to the air bag 2 at the second fix portion 52, so that the flap 4 is fixed in the closed position (see FIGS. 3 to 5) where the flap 4 closes the vent hole 21.

A direction connecting the first fix portion 41 and the second fix portion 52 is referred to as a first direction. A direction orthogonal to the first direction is referred to as a second direction.

In the airbag device 1 of Example 1, the first fix portion 41 is one end of the flap 4 in the first direction, and the connection end 43 is the other end of the flap 4 in the first direction.

For reference, in the present specification, if the first fix portion 41 and the second fix portion 52 are parallel to each other, a direction in which a straight line connecting the first fix portion 41 and the second fix portion 52 at the shortest distance extends, that is, a direction orthogonal to the first fix portion 41 and the second fix portion 52, is defined as the first direction. If the first fix portion 41 and the second fix portion 52 are not parallel to each other, a direction in which a straight line connecting a center of the first fix portion 41 and a center of the second fix portion 52 extends is defined as the first direction. In some cases, the first direction may be a direction in which a straight line connecting a center of gravity of the first fix portion 41 and a center of gravity of the second fix portion 52 extends.

The flap 4 in the airbag device 1 of Example 1 is made of the same nylon fabric as the air bag 2. The first sewing thread 40 sewing the flap 4 to the air bag 2 is made of nylon similarly to the air bag 2 and the flap 4.

As shown in FIG. 3, in the flap 4 of the airbag device 1 of Example 1, a relationship L3/L4 between a maximum length L3 between the first fix portion 41 and the connection end 43 in the first direction and a maximum length L4 of the first fix portion 41 in the second direction is approximately 0.8 and satisfies 0.5≤L3/L4≤3.0. A length of the flap 4 in the second direction is shorter on a side of the connection end 43 than that on a side of the first fix portion 41q.

The flap 4 in the airbag device 1 of Example 1 may be sandwiched between a first side and a second side and have a tapered shape in which a distance between the first side and the second side decreases from the side of the first fix portion 41 toward the side of the connection end 43. In the airbag device 1 of Example 1, an angle θ between the first side 401 and the second side 402 is approximately 55°.

As shown in FIG. 3, the vent hole 21 has a long-hole shape whose longitudinal direction is the first direction. The vent hole 21 has a shape in which two perfect circles having the same radius are connected by common external lines. In the airbag device 1 of Example 1, a relationship L1/L2 between a maximum length LI of the vent hole 21 in the first direction and a maximum length L2 of the vent hole 21 in the second direction is approximately 1.4.

As shown in FIG. 3, the flap 4 has a substantially triangular shape tapered from the side of the first fix portion 41 toward the side of the connection end 43, and the first fix portion 41 is linearly sewn to an inner surface side of the air bag 2 around the vent hole 21. The strap 5 extends in the first direction from the connection end 43 of the flap 4.

The strap 5 is made of the same nylon fabric as the air bag 2 and the flap 4, and has a thin band shape. The connection end 43 of the strap 5 is integral with the flap 4, and the second fix portion 52 of the strap 5 is sewn and fixed inside the air bag 2. Accordingly, the flap 4 covers the vent hole 21 inside the air bag 2 and is fixed in the closed position (FIGS. 4 and 5) in which the vent hole 21 is closed.

In the airbag device 1 of Example 1, the air bag 2 itself is the strap attachment portion described above. The second sewing thread 45 formed by sewing the strap 5 to the air bag 2 is a fixing material 50.

As shown in FIG. 1, the closed state release device 6 includes a heating device 60 and a cap 61, and is disposed outside the air bag 2. The closed state release device 6 heats and breaks the second sewing thread 45, that is, the fixing material 50. The closed state release device 6 in the airbag device 1 of Example 1 is a squib.

Hereinafter, an operation of the airbag device 1 of Example 1 will be described.

When an impact due to a collision or the like acts on the vehicle on which the airbag device 1 of Example 1 is mounted, the inflation fluid generation squib (not shown) is caused to operate by the control device (not shown), and the inflator 3 generates gas corresponding to the inflation fluid. The gas generated by the inflator 3 is supplied into the air bag 2. Accordingly, the air bag 2 is deployed and inflated. In this case, the flap 4 is in the closed position, and the vent hole 21 of the air bag 2 is covered with the flap 4 (FIGS. 3 to 5).

Immediately after the air bag 2 is deployed and inflated, the control device causes the closed state release device 6 to operate. Then, the closed state release device 6 generates heat, and the fixing material 50 is heated by the heat. Since the fixing material 50 is made of nylon which is a thermoplastic resin, the fixing material 50 is heated and broken.

Note that in the airbag device 1 of Example 1, the closed state release device 6 is set to operate to break the fixing material 50 at a timing when the occupant collides with the air bag 2.

Before deployment, that is, when the air bag 2 is folded, the flap 4 is fixed in the closed position by the strap 5. Even when the air bag 2 is deployed and inflated, the flap 4 is continuously fixed in the closed position by the strap 5. When the fixing material 50 is broken, the strap 5 is brought to be in a free state, and as a result, the flap 4 becomes a free state.

In this case, since the gas generated by the inflator 3 is continuously supplied to the inside of the air bag 2, the flap 4 is pressed toward the outside of the air bag 2 by a gas pressure from the inside to the outside of the air bag 2, and starts to change its position from the closed position where the vent hole 21 is closed to an open position where the vent hole 21 is opened. When the remaining part of the flap 4 and the strap 5 continuous with the flap 4 goes out of the air bag 2 through the vent hole 21, the vent hole 21 is opened (FIGS. 6 and 7). In this case, it can be said that the flap 4 is disposed in the open position opening the vent hole 21.

When the flap 4 opens the vent hole 21, the gas in the air bag 2 can flow out of the air bag 2 through the vent hole 21. Accordingly, the gas pressure inside the air bag 2 is sufficiently reduced, and an external force applied to the occupant due to the air bag 2 is also sufficiently reduced.

As shown in FIG. 3, in the flap 4 of the airbag device 1 of Example 1, the relationship L3/L4 between the maximum length L3 between the first fix portion 41 and the connection end 43 in the first direction and the maximum length L4 of the first fix portion 41 in the second direction is approximately 1.25, and it can be said that L4 is sufficiently larger than L3. Therefore, the tension acting on the flap 4 and the strap 5 in the closed position is sufficiently high and is difficult to be distributed in the second direction. Therefore, according to the airbag device 1 of Example 1, even the flap 4 having a relatively small area can effectively close the vent hole 21 in the closed position.

Further, since the tension acting on the flap 4 and the strap 5 in the closed position is sufficiently high, a reaction force when the fixing material 50 is broken to bring the strap 5 into the free state is also increased. Accordingly, according to the airbag device 1 of Example 1, the vent hole can be rapidly opened. With the cooperation, according to the airbag device 1 of Example 1, the opening and closing operation characteristics of the variable vent mechanism 11 are improved.

### Example 2

The airbag device 1 of Example 2 is substantially the same as the airbag device 1 of Example 1 except for the position of the vent hole. Hereinafter, the airbag device 1 of Example 2 will be described focusing on differences from the airbag device 1 of Example 1.

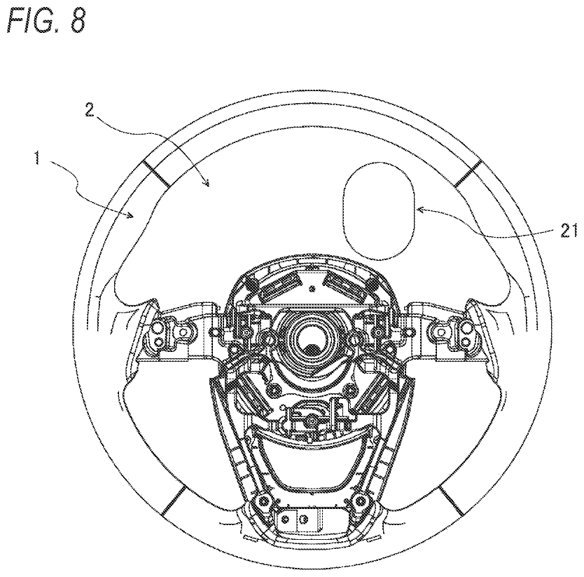

FIG. 8 is an explanatory diagram schematically illustrating the airbag device 1 of Example 2 in a state where the air bag 2 is deployed and inflated.

In the airbag device 1 of Example 1, the vent hole 21 is disposed above a central portion of the air bag 2, but in the airbag device 1 of Example 2, the vent hole 21 is disposed above an end of the air bag 2.

In the airbag device 1 of Example 2, the vent hole 21 is also provided on the bag wall surface 25 of the air bag 2, and the longitudinal direction thereof is directed to the first direction. In the airbag device 1 of Example 2, the variable vent mechanism 11 is the same as the variable vent mechanism 11 in the airbag device 1 of Example 1, and a positional relationship between the flap 4 and the strap 5 with respect to the vent hole 21 is also the same as that of the airbag device 1 of Example 1.

Therefore, according to the airbag device 1 of Example 2, similarly to the airbag device 1 of Example 1, the opening and closing operation characteristics of the variable vent mechanism 11 are also improved.

### Comparative Example

The airbag device 1 of a comparative example is substantially the same as the airbag device 1 of Example 1 except that the vent hole has a perfect-circle shape and the shape of the flap mechanism 10. Hereinafter, the airbag device 1 of the comparative example will be described focusing on differences from the airbag device 1 of Example 1.

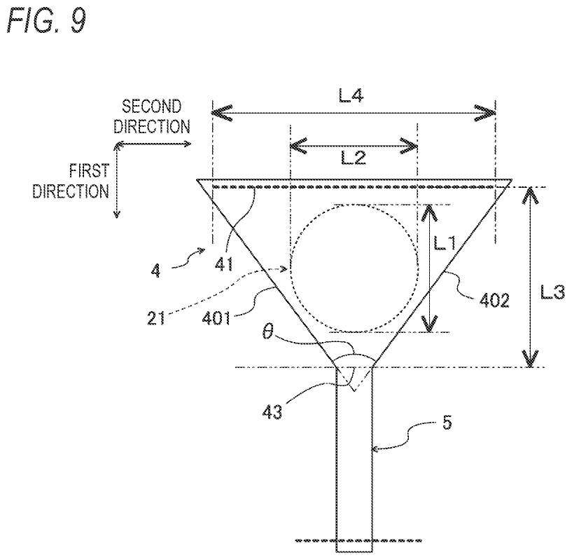

FIG. 9 is an explanatory diagram schematically illustrating the flap mechanism 10 and the vent hole in the airbag device 1 of the comparative example.

As described above, the vent hole 21 provided in the airbag device 1 of the comparative example has a perfect-circle shape. Accordingly, the relationship L1/L2 between the maximum length L1 of the vent hole 21 in the first direction and the maximum length L2 of the vent hole 21 in the second direction is 1. Further, in the airbag device 1 of the comparative example, the angle θ between the first side 401 and the second side 402 is approximately 75°.

The flap 4 has a tapered shape in which the length in the second direction gradually decreases from the side of the first fix portion 41 to the side of the connection end 43, and L3/L4 is approximately 0.4 and does not satisfy 0.5≤L3/L4≤3.0.

Therefore, the tension acting on the flap 4 and the strap 5 in the closed position in the airbag device 1 of the comparative example is inferior to that of the airbag device 1 of Example 1. Therefore, it is difficult to say that the flap 4 in the airbag device 1 of the comparative example closes the vent hole 21 effectively in the closed position, and it is also difficult to say that the vent hole 21 can be opened rapidly.

### Example 3

The airbag device 1 of Example 3 is substantially the same as the airbag device 1 of Example 1 except that the vent hole has a perfect-circle shape and the shape of the flap mechanism 10. Hereinafter, the airbag device 1 of Example 3 will be described focusing on differences from the airbag device 1 of Example 1.

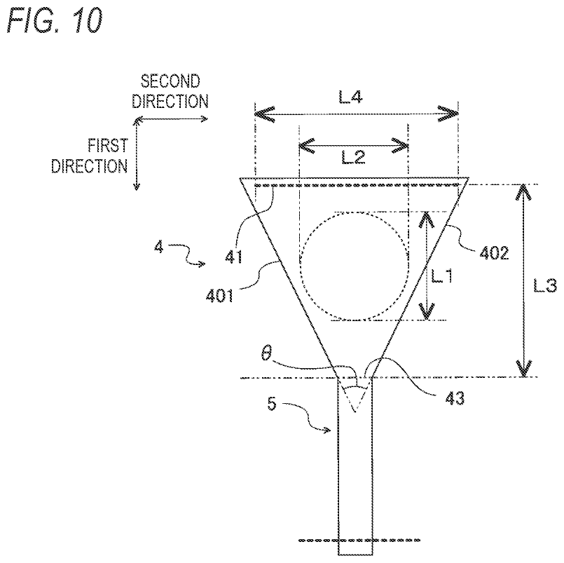

FIG. 10 is an explanatory diagram schematically illustrating the flap mechanism 10 and the vent hole in the airbag device 1 of Example 3.

The vent hole 21 in the airbag device 1 of Example 3 has a perfect-circle shape. Accordingly, the relationship L1/L2 between the maximum length L1 of the vent hole 21 in the first direction and the maximum length L2 of the vent hole 21 in the second direction is 1. Further, in the airbag device 1 of Example 3, the angle θ between the first side 401 and the second side 402 is approximately 50°.

The flap 4 has a tapered shape in which the length in the second direction gradually decreases from the side of the first fix portion 41 to the side of the connection end 43, and L3/L4 is approximately 1.0.

Therefore, in the airbag device 1 of Example 3, the tension acting on the flap 4 and the strap 5 in the closed position is also sufficiently large as in the airbag device 1 of Example 1. Therefore, in the airbag device 1 of Example 3, the flap 4 can also effectively close the vent hole 21 in the closed position and rapidly open the vent hole 21. That is, according to the airbag device 1 of Example 3, similarly to the airbag device 1 of Example 1, the opening and closing operation characteristics of the variable vent mechanism 11 are also improved.

### Example 4

The airbag device 1 of Example 4 is substantially the same as the airbag device 1 of Example 1 except that the vent hole has a perfect-circle shape and the shape of the flap mechanism 10. Hereinafter, the airbag device 1 of Example 4 will be described focusing on differences from the airbag device 1 of Example 1.

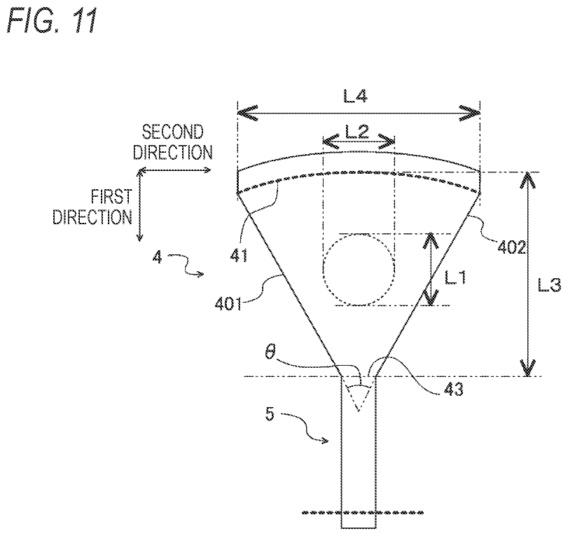

FIG. 11 is an explanatory diagram schematically illustrating the flap mechanism 10 and the vent hole in the airbag device 1 of Example 4.

The vent hole 21 in the airbag device 1 of Example 4 has a perfect-circle shape, and L1/L2 is 1. Further, in the airbag device 1 of Example 4, the angle θ between the first side 401 and the second side 402 is approximately 50°.

The flap 4 has a tapered shape in which the length in the second direction is gradually reduced from the side of the first fix portion 41 toward the side of the connection end 43, and the first fix portion 41 protrudes in an arc shape toward one end side in the first direction, that is, the opposite side to the strap 5. L3/L4 in the airbag device 1 of Example 4 is approximately 0.9.

In the airbag device 1 of Example 4, since L3/L4 is sufficiently large and 0.5≤L3/L4≤3.0 is satisfied, the tension acting on the flap 4 and the strap 5 in the closed position is also sufficiently large. Therefore, according to the airbag device 1 of Example 4, similarly to the airbag device 1 of Example 1, the opening and closing operation characteristics of the variable vent mechanism 11 are also improved.

### Example 5

The airbag device 1 of Example 5 is substantially the same as the airbag device 1 of Example 1 except for the shape of the flap mechanism 10. Hereinafter, the airbag device 1 of Example 5 will be described focusing on the difference from the airbag device 1 of Example 1.

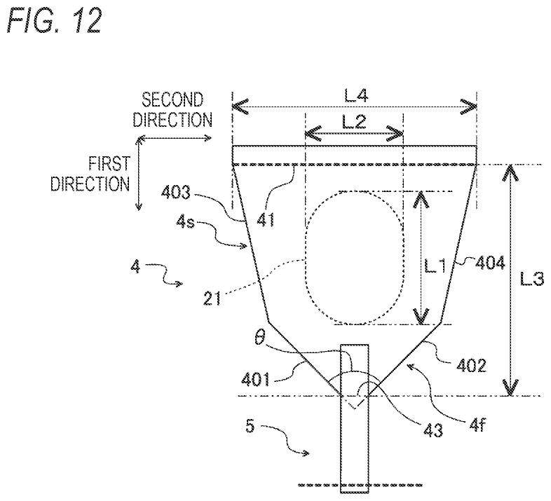

FIG. 12 is an explanatory diagram schematically illustrating the flap mechanism 10 and the vent hole in the airbag device 1 of Example 5.

The vent hole 21 in the airbag device 1 of Example 5 has a long-hole shape, and L1/L2 is approximately 1.4. Further, in the airbag device 1 of Example 5, the angle θbetween the first side 401 and the second side 402 is approximately 90°.

The flap 4 has a first region 4f which is a region on the side of the connection end 43 and a second region 4s which is a region on the side of the first fix portion 41.

The first region 4f is sandwiched between the first side 401 and the second side 402, and has a tapered shape in which the distance between the first side 401 and the second side 402 decreases from the side of the first fix portion 41 toward the side of the connection end 43.

The second region 4s is sandwiched between a third side 403 and a fourth side 404, and has a tapered shape in which a distance between the third side 403 and the fourth side 404 decreases from the side of the first fix portion 41 toward the side of the connection end 43.

The angle θ formed by the first side 401 and the second side 402 is smaller than an angle θ0 (not shown) formed by the third side 403 and the fourth side 404.

In the airbag device 1 of Example 5, since L3/L4 is approximately 0.9 and 0.5≤L3/L4≤3.0 is satisfied, the tension acting on the flap 4 and the strap 5 in the closed position is also sufficiently large. Therefore, according to the airbag device 1 of Example 5, similarly to the airbag device 1 of Example 1, the opening and closing operation characteristics of the variable vent mechanism 11 are also improved.

### Example 6

The airbag device 1 of Example 6 is substantially the same as the airbag device 1 of Example 1 except for the shape of the flap mechanism 10. Hereinafter, the airbag device 1 of Example 6 will be described focusing on the difference from the airbag device 1 of Example 1.

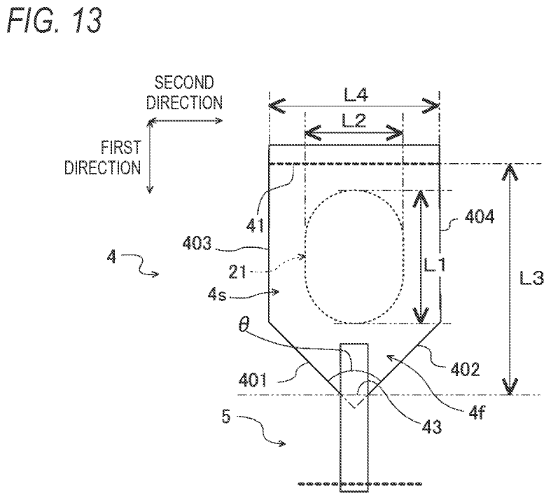

FIG. 13 is an explanatory diagram schematically illustrating the flap mechanism 10 and the vent hole in the airbag device 1 of Example 6.

The vent hole 21 in the airbag device 1 of Example 6 has a long-hole shape, and L1/L2 is approximately 1.4. Further, in the airbag device 1 of Example 6, the angle θ between the first side 401 and the second side 402 is approximately 90°.

In the airbag device 1 of Example 6, the flap 4 also has the first region 4f which is a region on the side of the connection end 43 and the second region 4s which is a region on the side of the first fix portion 41.

The first region 4f is sandwiched between the first side 401 and the second side 402, and has a tapered shape in which the distance between the first side 401 and the second side 402 decreases from the side of the first fix portion 41 toward the side of the connection end 43.

The second region 4s has a substantially rectangular shape sandwiched between the third side 403 extending in the first direction and the fourth side 404 also extending in the first direction.

In the airbag device 1 of Example 6, since L3/L4 is as large as approximately 1.4 and 0.5≤L3/L4≤3.0 is satisfied, the tension acting on the flap 4 and the strap 5 in the closed position is also sufficiently large. Therefore, according to the airbag device 1 of Example 6, similarly to the airbag device 1 of Example 1, the opening and closing operation characteristics of the variable vent mechanism 11 are also improved.

### Example 7

The airbag device 1 of Example 7 is substantially the same as the airbag device 1 of Example 1 except for the shape of the flap mechanism 10. Hereinafter, the airbag device 1 of Example 7 will be described focusing on the difference from the airbag device 1 of Example 1.

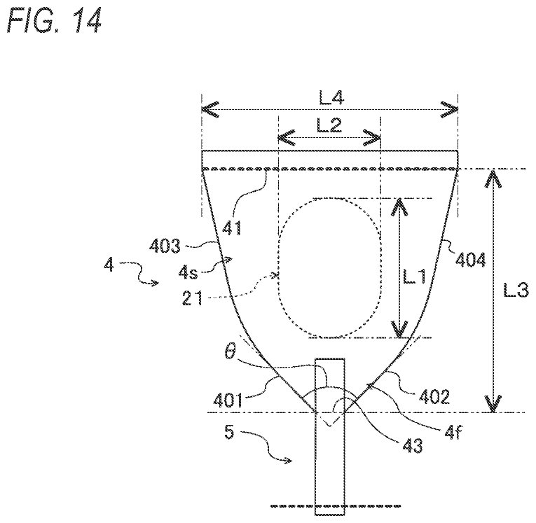

FIG. 14 is an explanatory diagram schematically illustrating the flap mechanism 10 and the vent hole in the airbag device 1 of Example 7.

The vent hole 21 in the airbag device 1 of Example 7 has a long-hole shape, and L1/L2 is approximately 1.4. Further, in the airbag device 1 of Example 7, the angle θbetween the first side 401 and the second side 402 is approximately 90°.

In the airbag device 1 of Example 7, the flap 4 also has the first region 4f which is a region on the side of the connection end 43 and the second region 4s which is a region on the side of the first fix portion 41.

The first region 4f is sandwiched between the first side 401 and the second side 402, and has a tapered shape in which the distance between the first side 401 and the second side 402 decreases from the side of the first fix portion 41 toward the side of the connection end 43.

The second region 4s is sandwiched between a third side 403 and a fourth side 404, and has a tapered shape in which a distance between the third side 403 and the fourth side 404 decreases from the side of the first fix portion 41 toward the side of the connection end 43.

The angle θ formed by the first side 401 and the second side 402 is smaller than an angle θ₀ (not shown) formed by the third side 403 and the fourth side 404.

A boundary between the first region 4f and the second region 4s is smoothly continuous. In other words, the first side 401 and the third side 403 are connected in a curved manner, and the second side 402 and the fourth side 404 are also connected in a curved manner.

In the airbag device 1 of Example 7, since L3/L4 is as large as approximately 1.0 and 0.5≤L3/L4≤3.0 is satisfied, the tension acting on the flap 4 and the strap 5 in the closed position is also sufficiently large. Therefore, according to the airbag device 1 of Example 7, similarly to the airbag device 1 of Example 1, the opening and closing operation characteristics of the variable vent mechanism 11 are also improved.

### Example 8

The airbag device 1 of Example 8 is substantially the same as the airbag device 1 of Example 1 except for the shape of the flap mechanism 10. Hereinafter, the airbag device 1 of Example 8 will be described focusing on the difference from the airbag device 1 of Example 1.

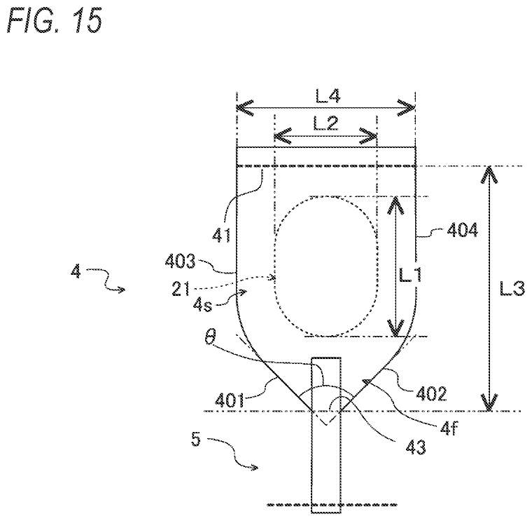

FIG. 15 is an explanatory diagram schematically illustrating the flap mechanism 10 and the vent hole in the airbag device 1 of Example 8.

The vent hole 21 in the airbag device 1 of Example 8 has a long-hole shape, and L1/L2 is approximately 1.4. Further, in the airbag device 1 of Example 8, the angle θ between the first side 401 and the second side 402 is approximately 90°.

In the airbag device 1 of Example 8, the flap 4 also has the first region 4f which is a region on the side of the connection end 43, and the second region 4s which is a region on the side of the first fix portion 41.

The first region 4f is sandwiched between the first side 401 and the second side 402, and has a tapered shape in which the distance between the first side 401 and the second side 402 decreases from the side of the first fix portion 41 toward the side of the connection end 43.

The second region 4s has a substantially rectangular shape sandwiched between the third side 403 extending in the first direction and the fourth side 404 extending in the first direction.

A boundary between the first region 4f and the second region 4s is smoothly continuous. In other words, the first side 401 and the third side 403 are connected in a curved manner, and the second side 402 and the fourth side 404 are also connected in a curved manner.

In the airbag device 1 of Example 8, since L3/L4 is as large as approximately 1.4 and 0.5≤L3/L4≤3.0 is satisfied, the tension acting on the flap 4 and the strap 5 in the closed position is also sufficiently large. Therefore, according to the airbag device 1 of Example 8, similarly to the airbag device 1 of Example 1, the opening and closing operation characteristics of the variable vent mechanism 11 are also improved.

### Example 9

The airbag device 1 of Example 9 is substantially the same as the airbag device 1 of Example 1 except for the shape of the flap mechanism 10. Hereinafter, the airbag device 1 of Example 9 will be described focusing on the difference from the airbag device 1 of Example 1.

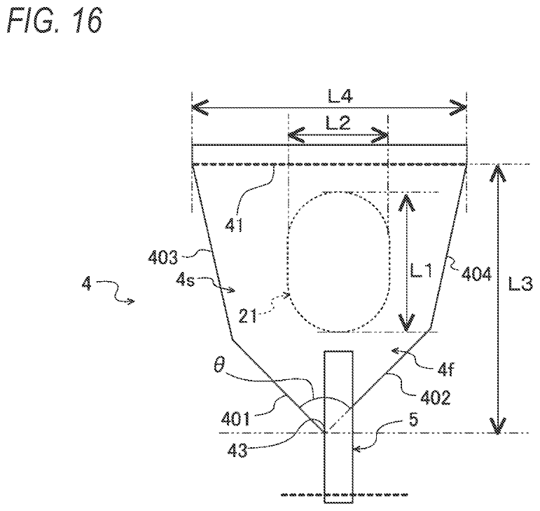

FIG. 16 is an explanatory diagram schematically illustrating the flap mechanism 10 and the vent hole in the airbag device 1 of Example 9.

The vent hole 21 in the airbag device 1 of Example 9 has a long-hole shape, and L1/L2 is approximately 1.4. Further, in the airbag device 1 of Example 7, the angle θ between the first side 401 and the second side 402 is approximately 90°.

In the airbag device 1 of Example 9, the flap 4 also has the first region 4f which is a region on the side of the connection end 43, and the second region 4s which is a region on the side of the first fix portion 41.

The first region 4f is sandwiched between the first side 401 and the second side 402, and has a tapered shape in which the distance between the first side 401 and the second side 402 decreases from the side of the first fix portion 41 toward the side of the connection end 43.

The second region 4s is sandwiched between a third side 403 and a fourth side 404, and has a tapered shape in which a distance between the third side 403 and the fourth side 404 decreases from the side of the first fix portion 41 toward the side of the connection end 43.

The angle θ formed by the first side 401 and the second side 402 is smaller than an angle θ₀ (not shown) formed by the third side 403 and the fourth side 404.

In the airbag device 1 of Example 9, the vent hole 21 is at a position slightly deviated in the second direction from a center of the flap 4 in the closed position.

Further, in the airbag device 1 of Example 9, the connection end 43 is also at a position slightly deviated from the center of the flap 4 in the second direction. Therefore, the length between the first fix portion 41 and the connection end 43 in the first direction is much greater on one side in the second direction than on the other side.

In the airbag device 1 of Example 9, since the relationship L3/L4 between the maximum length L3 between the first fix portion 41 and the connection end 43 in the first direction and a maximum length L4 of the first fix portion 41 in the second direction is as sufficiently large as approximately 1.0 and 0.5≤L3/L4≤3.0 is satisfied, the tension acting on the flap 4 and the strap 5 in the closed position is also sufficiently large. Therefore, according to the airbag device 1 of Example 9, similarly to the airbag device 1 of Example 1, the opening and closing operation characteristics of the variable vent mechanism 11 are also improved.

Although the present disclosure has been described above, the present invention is not limited to the above-described embodiments and the like, the elements described in the embodiments and the like can be appropriately extracted and combined, and various modifications can be made without departing from the scope of the present invention.

In addition, the description of the present disclosure is not limited to the citation relationships of claims at the beginning of the application, and discloses a technical idea obtained by appropriately combining the matters described in each claim.

1. A variable vent mechanism comprising:
an air bag being in a bag-shape, and having a vent hole formed to be opened and provided on a bag wall surface of the air bag;
a flap attached to the air bag at a first fix portion, and configured to cover the vent hole;
a strap extending from a connection end of the flap, fixed to a strap attachment portion at a second fix portion, and configured to fix the flap in a closed position where the vent hole is closed; and
a closed state release device bringing the strap into a free state to change a position of the flap from the closed position,
wherein in the flap, a relationship L3/L4 between a maximum length L3 between the first fix portion and the connection end in a first direction connecting the first fix portion and the second fix portion, and a maximum length L4 of the first fix portion in a second direction orthogonal to the first direction satisfies 0.5≤L3/L4≤3.0, and
a length of the flap in the second direction is shorter on a side of the connection end than that on a side of the first fix portion.

2. The variable vent mechanism according to claim 1,
wherein the vent hole has a long-hole shape in which a maximum length L1 in the first direction is longer than a maximum length L2 in the second direction.

3. The variable vent mechanism according to claim 2,
wherein a relationship L1/L2 between the maximum length L1 and the maximum length L2 satisfies 1.0<L1/L2≤3.0.

4. The variable vent mechanism according to claim 1,
wherein a region of the flap on a side of the connection end is sandwiched between a first side and a second side, and
the region has a tapered shape in which a distance between the first side and the second side decreases from the first fix portion side toward the connection end side.

5. An airbag device comprising the variable vent mechanism according to claim 1.

6. A flap mechanism comprising:
a flap attached, at a first fix portion, to an air bag being in a bag-shape and having a vent hole formed to be opened and provided on a bag wall surface of the air bag, and configured to cover the vent hole; and
a strap extending from a connection end of the flap, fixed to a strap attachment portion at a second fix portion, and configured to fix the flap in a closed position where the vent hole is closed,
wherein in the flap, a relationship L3/L4 between a maximum length L3 between the first fix portion and the connection end in a first direction connecting the first fix portion and the second fix portion, and a maximum length L4 of the first fix portion in a second direction orthogonal to the first direction satisfies 0.5≤L3/L4≤3.0, and
a length of the flap in the second direction is shorter on a side of the connection end than that on a side of the first fix portion.
